(19) United States
(12) Patent Application Publication
(10) Pub. No.: US 2022/0188688 A1
(43) Pub. Date: Jun. 16, 2022

(54) METHOD AND SYSTEM FOR DISTRIBUTED TRAINING USING SYNTHETIC GRADIENTS

(71) Applicant: LightOn, Paris (FR)

(72) Inventors: Julien Launay, Paris (FR); Iacopo Poli, Paris (FR); Kilian Müller, Paris (FR); Gustave Pariente, Paris (FR); Igor Carron, Paris (FR); Laurent Daudet, Paris (FR)

(73) Assignee: LightOn, Paris (FR)

(21) Appl. No.: 17/117,925

(22) Filed: Dec. 10, 2020

(51) Int. Cl. G06N 20/00; G06F 9/50; G06F 9/52

(52) U.S. Cl. CPC G06N 20/00; G06F 9/52; G06F 9/5083

(57) ABSTRACT

A training node may include a first processor coupled to a first memory, and a second processor coupled to a second memory. The training node may further include a synthetic gradient processing unit (SGPU) coupled to a third memory, the first processor and the second processor. A portion of an electronic model may be disposed in the first memory, the second memory, and the third memory. The SGPU may generate a synthetic gradient signal based on an error data signal from the first processor and the portion of the electronic model. The synthetic gradient signal may update the electronic model during a training operation for the electronic model.

### BACKGROUND

Machine learning is an important technology for approximating complex solutions. For example, a model may be trained to predict real data using a training dataset over an iterative process. However, machine learning algorithms may require extensive datasets and computing power to generate a model with sufficient accuracy.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a system that includes various training nodes including a first training node and a second training node. The first training node includes a synthetic gradient processing unit (SGPU), various processors, and at least one memory. The system further includes a distributed training controller including a processor and a memory, the distributed training controller coupled to the training nodes. The distributed training controller determines, using a distribution algorithm, a resource distribution among the training nodes. The first training node trains an electronic model based on the resource distribution and parallel processing. The distributed training controller transmits, to the first training node, the electronic model and training data. The SGPU obtains an error data signal from at least one processor among the processors. The electronic model is updated based on a synthetic gradient signal that is obtained from the SGPU in response to the error data signal.

In general, in one aspect, embodiments relate to a training node that includes a first processor coupled to a first memory, and a second processor coupled to a second memory. The training node further includes a synthetic gradient processing unit (SGPU) coupled to a third memory, the first processor and the second processor. A portion of an electronic model is disposed in the first memory, the second memory, and the third memory. The SGPU generates a synthetic gradient signal based on an error data signal from the first processor and the portion of the electronic model. The synthetic gradient signal updates the electronic model during a training operation for the electronic model.

In general, in one aspect, embodiments relate to a method that includes obtaining, by a distributed training controller, training data and an electronic model. The method includes determining, by the distributed training controller and based on a distribution algorithm, a resource distribution for updating the electronic model using various training nodes. At least one training node among the training nodes includes a synthetic gradient processing unit (SGPU). The electronic model is updated based on a synthetic gradient signal that is generated by the SGPU in response to an error data signal. The method includes generating, using the training nodes, the training data, and the resource distribution, a trained model based on the electronic model.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1 and 2 show systems in accordance with one or more embodiments.

FIGS. 3A, 3B, 4, and 5 show examples in accordance with one or more embodiments.

FIG. 6 shows a flowchart in accordance with one or more embodiments.

FIGS. 7, 8, and 9 show systems in accordance with one or more embodiments.

FIG. 10 shows a flowchart in accordance with one or more embodiments.

FIGS. 11A and 11B show an example in accordance with one or more embodiments.

FIGS. 12A and 12B shows a computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for using distributed training for updating various types of machine learning models. For example, a machine learning model may be embodied as an electronic model with multiple hidden layers. These various hidden layers may be updated during a training operation using synthetic gradients generated by synthetic gradient processing units (SGPUs). In particular, an SGPU may be a component within a training node, where multiple training nodes may form a distributed training network for performing a particular training operation of an electronic model.

Furthermore, distributed training approaches may enable training of extreme-scale machine learning models with billions of parameters by spreading the electronic model over many training nodes. While various distributed training approaches enable scaling of processor resources and memory, some approaches may be bottlenecked by communication bandwidth available between training nodes. Because many training approaches use backpropagation, and backpropagation is fundamentally sequential and non-local, a large amount of communicating must occur between layers of a machine learning model, as the training operation is distributed among multiple nodes. This limit on communication may also prevent scaling of large electronic models.

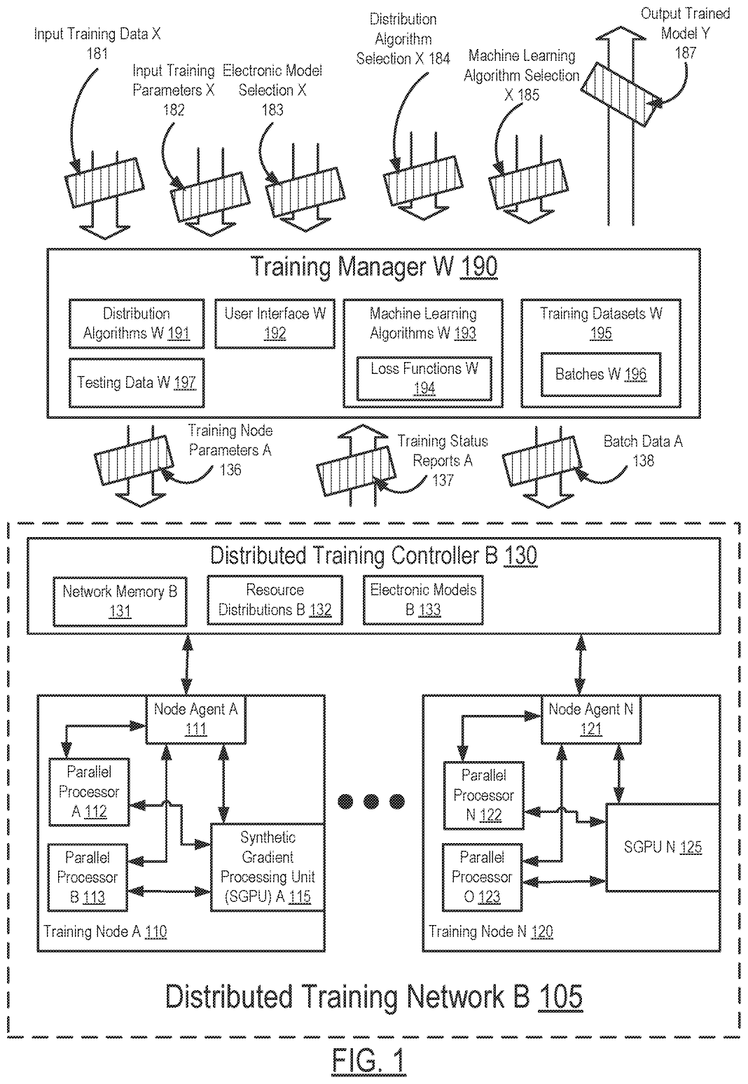

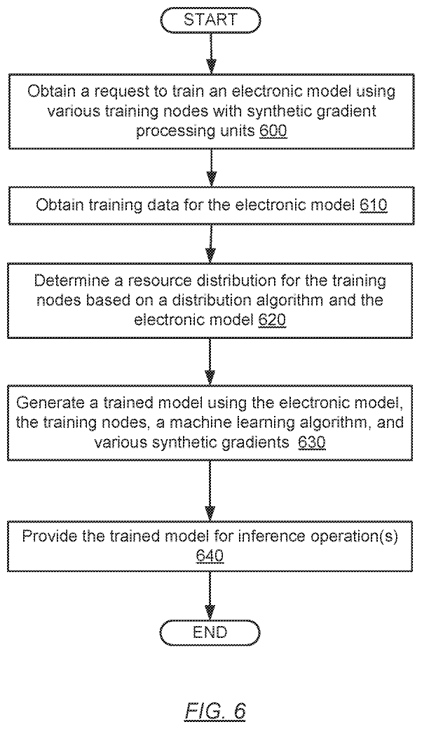

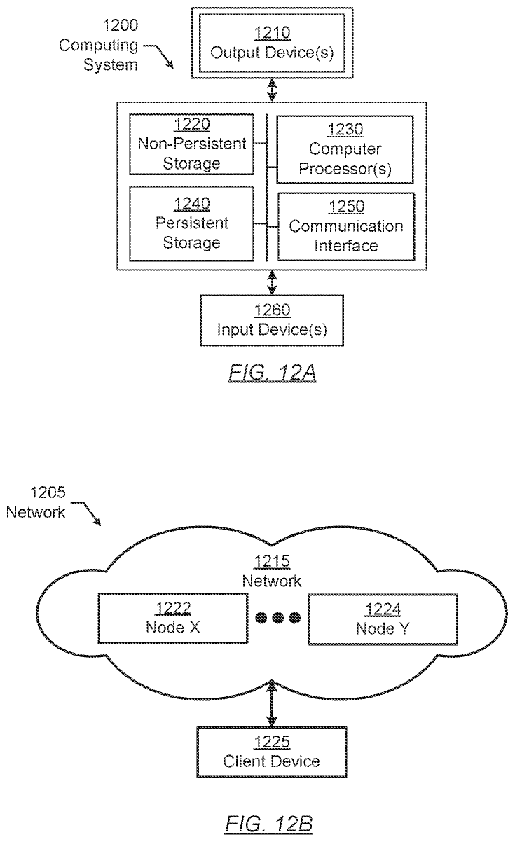

Turning to FIG. 1, FIG. 1 shows a schematic diagram in accordance with one or more embodiments. As shown in FIG. 1, a distributed training network (e.g., distributed training network B (105)) may include a distributed training controller (e.g., distributed training controller B (130))) coupled to various training nodes (e.g., training node A (110), training node N (120)) for performing one or more training operations using parallel processing. In particular, a training operation may include training one or more electronic models (e.g., electronic models B (133)) using training data (e.g., training datasets W (195)) to optimize various model parameters, such as model weights. An electronic model may be a deep learning model, such as a deep neural network, a transformer, and various other types of machine learning models. For more information on electronic models, see Block 610 in FIG. 6 and the accompanying description. In some embodiments, a distributed training network may be similar to network (1220) described below in FIGS. 12A and 12B, and the accompanying description.

In some embodiments, a training node includes one or more synthetic gradient processing units (e.g., SGPU A (115), SGPU N (125)). More specifically, different portions of a training operation may be allocated to different resources within a training node and/or among different training nodes. For example, some parallel processors may be responsible for performing forward passes through a deep neural network, while an SGPU may perform synthetic gradient computations for updating one or more hidden layers of the same deep neural network. Thus, an SGPU may include hardware and/or software for determining some or all of the synthetic gradients during a particular epoch of a training operation. As such, synthetic gradient operations may be performed in place of backpropagation operations, where these synthetic gradient operations may be offloaded to the SGPU. By using a dedicated co-processor to determine synthetic gradients, for example, inter-layer and inter-node communications may be reduced during training operations of large electronic models. Likewise, available memory in some training nodes may be increased through this offloading architecture, thereby enabling storage of larger models in a training node. As such, an SGPU may be an application specific integrated circuit (ASIC), a field programmable gate array (FPGA), as well as various other types of integrated circuits and computer devices.

In regard to synthetic gradients, in some embodiments, an electronic model may be trained using a direct feedback alignment algorithm rather than a backpropagation algorithm. Similar to a backpropagation algorithm, error data is determined in a direct feedback alignment (DFA) algorithm between training data and predicted data from an electronic model. However, an error vector may be determined for updating weight values for multiple hidden layers concurrently (instead of a single hidden layer). Thus, in some embodiments, a direct feedback alignment algorithm determines synthetic gradients by projecting the error vector to the dimensions of the hidden layers using matrices. For example, an SGPU may obtain a random projection of error data that is subsequently used to determine various synthetic gradients. The synthetic gradients may then be used to update the electronic model.

In some embodiments, an electronic model may be trained using a local error signals (LES) algorithm rather than a backpropagation algorithm. In a LES algorithm, error data is determined at the hidden layer level, using a local subnetwork and local error values from local loss functions. Rather than analyzing predicted data only at the output layer of an electronic model, a LES algorithm may determine predicted data for one or more hidden layers inside the electronic model. For example, a local subnetwork in the electronic model may obtain output values from one or more previous hidden layers. Thus, predicted data for various local subnetworks may be determined. In some embodiments, the LES algorithm may determine synthetic gradients by obtaining local error values from evaluating local loss functions using the local subnetwork predicted data and training data. Examples of local loss functions may include a local cross-entropy function and a similarity matching loss function, which may use the training data, the hidden layer data, and the hidden layer output as processed by the local subnetwork to determine synthetic gradients. For example, an SGPU may determine a local subnetwork predicted data that is subsequently used to determine various local error signals and synthetic gradients. The synthetic gradients may then be used to update the electronic model.

In some embodiments, a DFA algorithm, a LES algorithm, and/or a backpropagation algorithm may be combined in a training operation. Synthetic gradients for specific hidden layers may be obtained using a DFA algorithm and using LES for other hidden layers. For example, fully-connected hidden layers may use a DFA algorithm, while convolutional layers may use a LES algorithm. The synthetic gradient signal obtained by a DFA algorithm or a LES algorithm at a given hidden layer may also be propagated to upstream layers using backpropagation. As such, synthetic gradients may drive the machine learning process for the various hidden layers. Using this corresponding predicted data, an SGPU may update the electronic model using synthetic gradients in contrast to an ordinary gradient update mechanism implemented with a backpropagation algorithm.

For illustration of some embodiments, a deep neural network may include ten layers that include eight consecutive hidden layers between an input layer and an output layer (i.e., layer 1, layer 2, . . . layer 10). Synthetic gradients may be generated for layer 3, layer 6, and layer 9. Using the synthetic gradients for these respective layers, regular gradients may be generated for layer 1, layer 2, from the synthetic gradients of layer 3, layer 4, layer 5, from the synthetic gradients of layer 6, layer 7, and layer 8, from the synthetic gradients of layer 9, using backpropagation.

In some embodiments, an SGPU includes one or more optical circuits with functionality for determining synthetic gradients. For example, an optical circuit may include an adjustable spatial light modulator that includes functionality for generating a combined optical signal at an optical detector. This combined optical signal may be generated by combining an optical signal from an optical source with a resulting optical signal that is produced by transmitting an optical signal through a medium at a predetermined spatial light modulation. The optical circuit may include various optical components, such as electro-optical modulators, beam splitters, beam mixers, optical detectors, optical sources, interferometers, optical waveguides, etc. As such, an optical circuit may provide a scalable approach for increasing the computational speed of synthetic gradient processing in a training node or a distributed training network. However, some embodiments are contemplated that include electronics-only SGPUs without any optical circuits. In some embodiments, a distributed training network may include both electronics-only SGPUs as well as SGPUs with optical circuits. For more information on using direct feedback alignment algorithms and optical circuits to generate synthetic gradients, see the section below titled Synthetic Gradient Processing and the accompanying description.

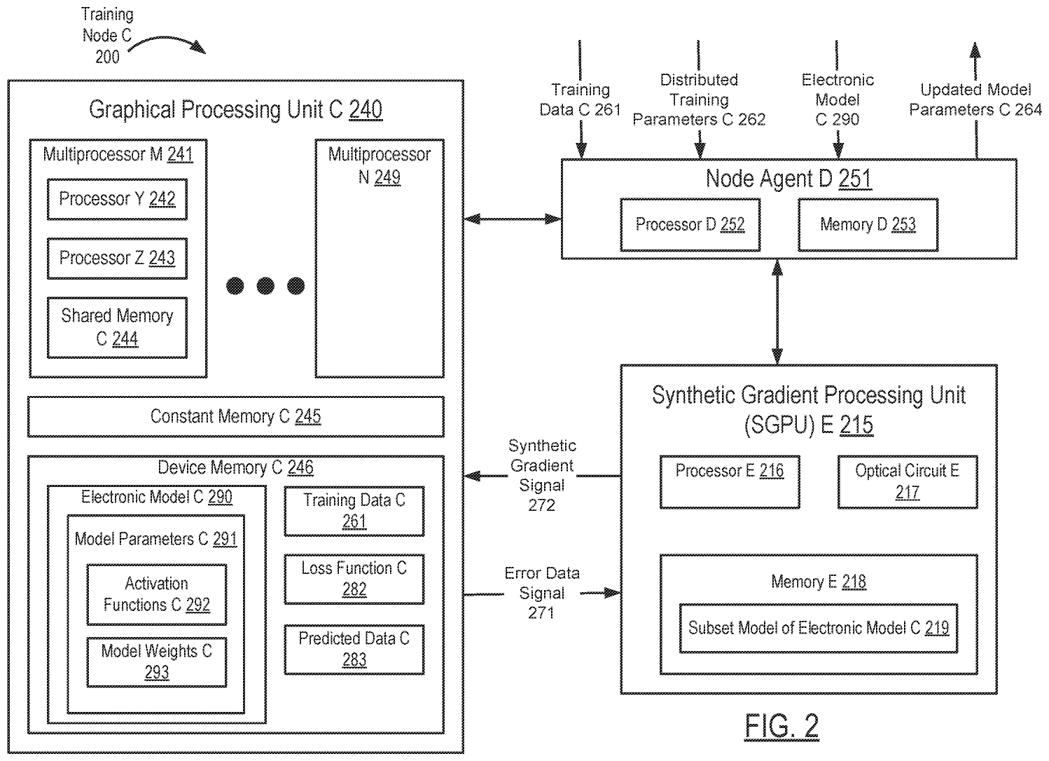

Turning to FIG. 2, FIG. 2 shows a schematic diagram in accordance with one or more embodiments. As illustrated in FIG. 2, a training node (e.g., training node C (200)) may include one or more graphical processing units (e.g., graphical processing unit (GPU) C (240)) coupled to an SGPU (e.g., SGPU E (215)) and a node agent (e.g., node agent D (251)). In particular, a GPU may include various hardware, such as a set of multiprocessors (e.g., multiprocessor M (241), multiprocessor N (249)), where a respective multiprocessor may include multiple individual processors (e.g., processor Y (242), processor Z (243), which may be referred to as “cores”), and one or more shared memories (e.g., shared memory C (244)). As such, a GPU may perform a specific operation that may be referred to as a “kernel” that is performed using multiple hardware threads operating in parallel. For example, a GPU may execute the kernel using one or more thread blocks, where a thread block includes a group of single instruction, multiple data (SIMD) threads. As such, multiple thread blocks may be executed by a single multiprocessor concurrently on a GPU. Thus, GPUs may include functionality for accelerating image generation, which may also make GPUs suitable hardware for executing parallel processing in order to train an electronic model. A processor may be a parallel processor and similar to the computer processor (1230) described below in FIGS. 12A and 12B and the accompanying description.

In some embodiments, a training node uses one or more GPUs (e.g., GPU C (240)) and an SGPU (e.g., SGPU E (215)) to determine a parameter update to an electronic model (e.g., electronic model C (290)). In regard to training node C (200), for example, the SGPU E (215) includes a processor E (216), a memory (218) that stores a subset model (219) of the electronic model C (290), and an optical circuit E (217). Based on an error data signal (271) obtained from the GPU C (240), the SGPU E (215) uses the optical circuit E (217) and the stored subset model (219) to determine a synthetic gradient signal (272). An error data signal may be an electrical signal that corresponds to error data produced by one or more loss functions (e.g., loss function C (282)) with respect to an electronic model (e.g., electronic model C (290)). For example, the loss function C (282) may determine a mismatch value between training data C (261) and predicted data C (283) by the current parameters of electronic model C (290). This mismatch value may be represented as an analog control signal or a data signal that is transmitted as the error data signal (271) to the SGPU E (215). At the SGPU E (215), the SGPU E (215) may use the error data signal (271) to determine synthetic gradients for a portion or all hidden layers in the electronic model C (290). Accordingly, a synthetic gradient signal may also be an analog control signal or a data signal that encodes a parameter update based on the computed synthetic gradients. As such, the SGPU E (215) may transmit the synthetic gradient signal (271) to the GPU C (240) or outside training node C (200), e.g., as a portion of the updated model parameters C (264).

While a single loss function is shown in training node C (200), various embodiments are contemplated using two or more loss functions in a single training node. For example, the electronic model C (290) may be a subset model that corresponds to only a portion of a complete electronic model (e.g., similar to subset model (219) in memory E (218)). In this embodiment, loss function C (282) may be a local loss function that produces error data for determining synthetic gradients that approximate a true gradient. In some embodiments, different types of loss functions are used to determine the synthetic gradients. For example, a local cross-entropy function and a similarity matching loss function may be used together to determine the synthetic gradients for a subset model.

Keeping with FIG. 2, a training node may include a node agent (e.g., node agent D (251)). In particular, a node agent may include hardware and/or software with functionality for managing a training node and communicating to a distributed training controller (e.g., distributed training controller B (130) may communicate directly with node agent A (111) and/or node agent N (121)) and/or other training nodes in a distributed training network. In particular, a node agent may implement a particular type of resource distribution on a training node by providing commands to GPUs, parallel processors, SGPUs, etc. Thus, a node agent may include a processor (e.g., processor D (252)) and memory (e.g., memory D (253)) similar to other network components. However, a GPU or an SGPU may be a node agent in some embodiments, where a training node does not include a dedicated component for communicating over a distributed training network or managing the respective training node. As shown in FIG. 2, the node agent D (251) obtains training data C (261), distributed training parameters C (262), the electronic model C (290), and other network data not shown. The node agent D (251) may then relay the training data C (261), the distributed training parameters C (262), and the electronic model C (290) to other components inside the training node C (200). Likewise, data may be collected at the node agent D (251), such as from the GPU C (240) and/or the SGPU E (215), and then offloaded from the training node C (200) by the node agent C (251) (e.g., the updated model parameters C (264)).

Returning to GPUs, a GPU may include different types of memory hardware, such as register memory, shared memory, device memory, constant memory, texture memory, etc. For example, register memory and shared memory (e.g., shared memory C (244)) may be disposed on an actual GPU chip, while other types of memory may be separate components in the GPU. In particular, register memory may only be accessible to the hardware thread that wrote its memory values, which may only last throughout the respective thread's lifetime. On the other hand, shared memory may be accessible to all hardware threads within a thread block and shared memory values may exist for the duration of the thread block (e.g., shared memory enables hardware threads to communicate and share data between one another). Device memory (e.g., device memory C (246)) may be global memory that is accessible to any hardware threads within a GPU's application as well as devices outside the GPU, such as an SGPU or a node agent. Device memory may be allocated by a host for example, and may survive until the host deallocates the memory. Constant memory (e.g., constant memory C (245)) may be a read-only memory device that provides memory values that do not change over the course of a kernel execution (e.g., constant memory may provide data faster than device memory and thus reduce memory bandwidth). Texture memory (not shown) may be another read-only memory device that is similar to constant memory, where the memory reads in texture memory may be limited to physically adjacent hardware threads, e.g., those hardware threads in a warp.

In some embodiments, multiple GPUs, a node agent, and/or one or more SGPUs may communicate with each other using a peer-to-peer (P2P) communication protocol. For example, two GPUs may be attached to the same PCIe bus in a training node and communicate directly with each other. Thus, over a P2P communication protocol, a component in a training node may access a different memory in the same training node. In some embodiments, for example, the SGPU E (215) may not store locally the electronic model C (290), but may simply access the device memory C (246) in the GPU C (240) that stores electronic model C (290). Likewise, the P2P communication protocol may also enable direct memory transfers between training node components, e.g., to distribute synthetic gradients among multiple GPUs.

Returning to FIG. 1, training nodes may provide a centralized architecture or a decentralized architecture for distributed training. More specifically, different training architectures may have different attributes, such as different network topologies, bandwidths, communication latencies, parameter update frequencies, and/or desired fault tolerances. In a centralized architecture, for example, a distributed training controller may include hardware and/or software to provide a parameter server for aggregating parameter updates (such as synthetic gradients from multiple nodes) for an electronic model. Once aggregated, the parameter server may retransmit a complete parameter update to training nodes throughout the distributed training network. In a decentralized architecture, an individual training node may communicate model updates directly to other training nodes, e.g., using a broadcasting protocol or by transmitting signals directly to other training nodes. With decentralized updates, each training node may determine a complete parameter update separately after obtaining individual updates from the rest of the training nodes.

In some embodiments, a distributed training network may include one or more distributed training controllers (e.g., distributed training controller B (130)). In particular, a distributed training controller may include hardware and/or software with functionality for managing training resources, such as network memory (e.g., network memory B (131)) and one or more processors. Examples of training resources may include various training nodes and their respective components, such as parallel processors (e.g., parallel processor A (112), parallel processor B (113), parallel processor N (122), parallel processor O (123)), various memories, various network elements (such as routers and switches), GPUs, SGPUs, various types of artificial intelligence (AI) accelerators, such as tensor processing units (TPUs) and neural processing units, and/or other hardware and/or software operating in a distributed training network. A distributed training controller may be centralized server in some embodiments. Likewise, the distributed training controller may be a software-defined network controller, e.g., operating on various node agents throughout a distributed training network.

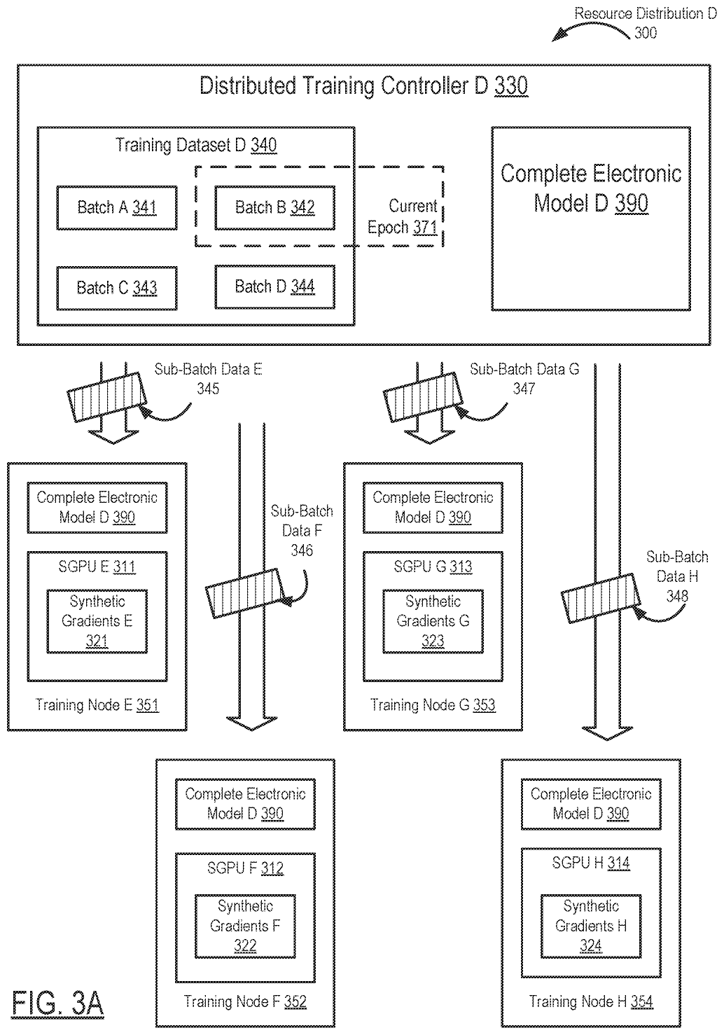

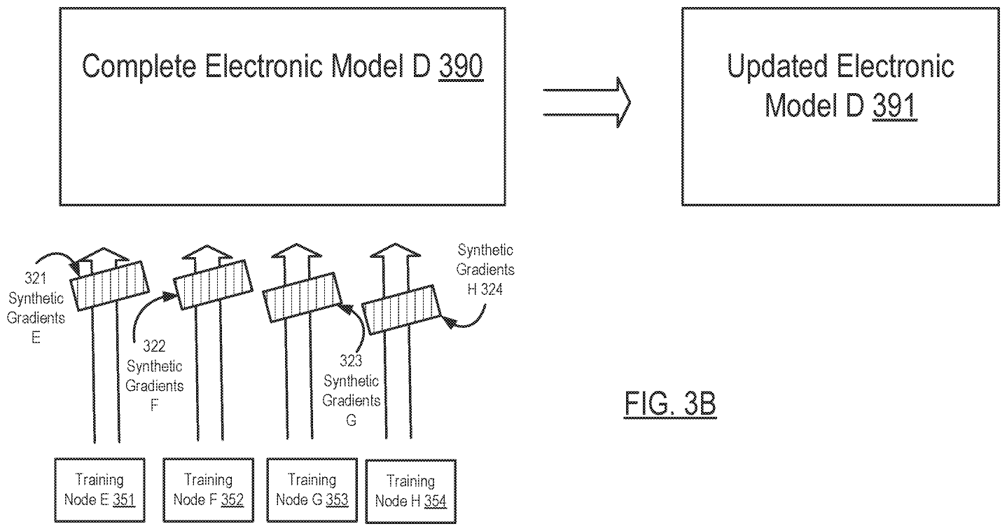

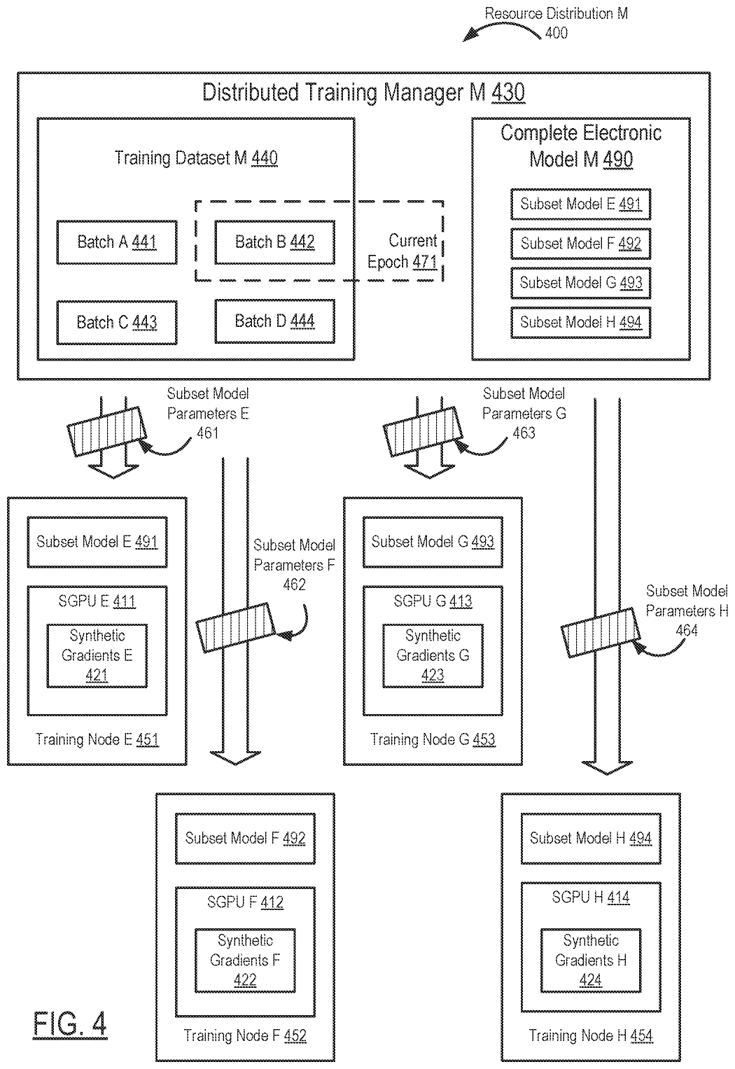

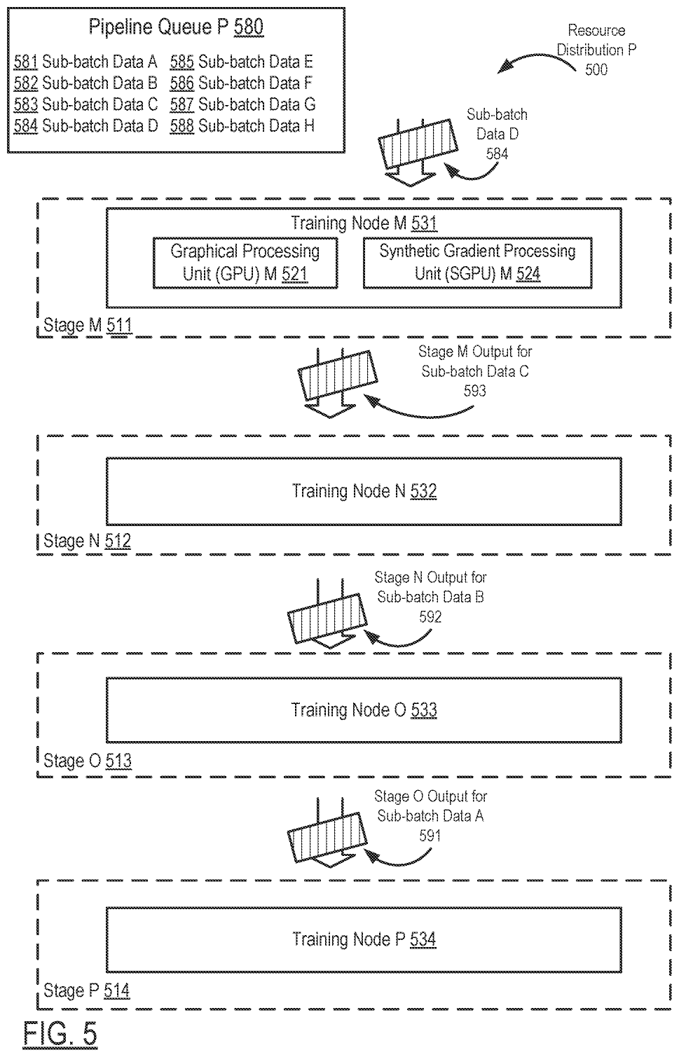

In some embodiments, a distributed training controller includes functionality for determining a predetermined resource distribution (e.g., resource distribution B (132)) for one or more training operations. In particular, a resource distribution may correspond to a particular parallelization configuration using one or more distribution algorithms (e.g., distribution algorithms W (191)), where a distribution algorithm may be a rule-based process, a probability-based process, and/or a machine learning process for managing training resources in a distributed training network. In other words, a resource distribution may divide training resources within a specific training node and/or between training nodes for performing a training operation. Examples types of parallel configurations include data parallelism (e.g., as described in FIGS. 3A and 3B and the accompanying description below), model parallelism (e.g., as described in FIG. 4 and the accompanying description below), pipeline parallelism (e.g., as described in FIG. 5 and the accompanying description below), and various hybrid parallelism types. In some embodiments, a resource distribution may be defined as a task graph that maps various resource dependencies between individual tasks associated with training operators e.g., communication tasks (e.g., data transfers between training resources) and data processing tasks (e.g., determining an output to a hidden layer or synthetic gradients for updating one or more hidden layers). In another example, a resource distribution may map hardware connections between different training resources (e.g., a GPU may transmit an error data signal to an SGPU that transmits a synthetic gradient signal to a different GPU).

With respect to data parallelism, a distribution algorithm may partition a batch of training data into various sub-batches for processing by different training nodes. To update model weights of an electronic model, components in a training node may access all model parameters of a complete electronic model at any time. For example, a copy of the electronic model may be stored on each training node in order to be accessed by various parallel processors, GPUs, SGPUs, etc. During a data parallelism training operation, synthetic gradients may be aggregated by a distributed training controller (e.g., acting as a parameter server) and the final model parameter update may be retransmitted to all of the training nodes.

With respect to model parallelism, a distribution algorithm may partition an electronic model to different training nodes, e.g., as various subset models. A subset model may be a portion of a complete electronic model (e.g., by including only a portion of the hidden layers in the complete electronic model). For example, a sub-batch of training data may be copied to different training nodes, and different parts of an electronic model may be assigned to different parallel processors on different training nodes. Model parallelism may conserve memory resources since a complete electronic model is not stored in a single place. However, this type of parallelism may incur additional communication overhead within a distributed training network. After a GPU determines a forward output of a subset model of a deep neural network, the GPU may need to relay the results of the forward output to a different training node responsible for determining the forward output of a different subset model of the deep neural network.

With respect to pipeline parallelism, a distribution algorithm may partition training resources with overlapping computations, e.g., between one hidden layer and the next hidden layer as data becomes available. Pipeline parallelism may also include partitioning an electronic model according to depth, such as by assigning specific hidden layers to specific training resources. Thus, pipeline parallelism may be a combination of data parallelism and model parallelism. In some embodiments, a distribution algorithm may partition the hidden layers of an electronic model into multiple stages. Each stage may correspond to a consecutive set of hidden layers in the model, where a respective stage may be mapped to separate training resources. For example, a training node may perform the forward pass and determine synthetic gradients for a set of hidden layers associated with a particular stage.

In some embodiments, pipeline parallelism differs from model parallelism by processing multiple sub-batches of data concurrently. For example, model parallelism may include multiple training nodes that are operating on the same sub-batch of data within a batch dataset. With pipeline parallelism, different stages of the corresponding resource distribution may be operating on different sub-batches of data. As such, one or more training nodes may be assigned to a respective stage in the resource distribution. Likewise, one stage may be using data parallelism for the sub-batch processing, while another stage may be using model parallelism for the sub-batch processing.

In contrast to data parallelism, for example, a distributed training controller may insert multiple sub-batches into a distributed training network in order to have multiple training nodes be active using different sub-batches at the same time. In other words, a distributed training controller may insert multiple sub-batches into a “pipeline” one after the other. After completing its forward pass for an initial sub-batch, a stage may asynchronously transmit various output activations to the next stage while simultaneously initiating the training process for another sub-batch. As such, one or more components in a training node may determine whether (1) to perform its stage's forward pass for a sub-batch, pushing the sub-batch to downstream nodes, or (2) to perform its stage's synthetic gradient operation for a different sub-batch and push the synthetic gradients to upstream nodes.

Accordingly, a distribution algorithm may determine various stages based on different amounts of computation time for different forward passes across various layers 1, the size of the output activations of individual layers, and/or the size of weight parameters for individual layers. Likewise, the distribution algorithm may determine various stages based on an amount of communication time necessary for transfer data between upstream and/or downstream nodes.

Returning to FIG. 1, in some embodiments, a training manager (e.g., training manager W (190)) is coupled to a distributed training network (e.g., distributed training network B (105)). In particular, a training manager may include hardware and/or software for providing a cloud computing system that may perform one or more training operations to produce a trained model (e.g., output trained model Y (187)) without direct active management by a user device or local computer system. For example, the training manager may store distribution algorithms (e.g., distribution algorithms W (191), testing data for validating a model (e.g. testing data W (197)), various machine learning algorithms (e.g., machine learning algorithms W (193)) with various loss functions (e.g., loss functions W (194)), and various training datasets (e.g. training datasets W (195)) that may be divided into various batches (e.g., batches W (196)) for various machine learning epochs of a training operation.

Furthermore, the training manager may obtain various inputs from a user seeking to train an electronic model, such as input training data (e.g., input training data X (181), input training parameters (e.g., input training parameters X (182), one or more electronic model selections (e.g., electronic model selection X (183)), a distribution algorithm selection (e.g., distribution algorithm selection X (184)), and/or a machine learning algorithm selection (e.g., a machine learning algorithm selection X (185)). Based on a user's selections, a training manager may transmit training node parameters (e.g., training node parameters A (136)) and/or batch data (e.g., batch data A (138)) to a distributed training network to implement the corresponding training operation.

Example input training data may include acquired data, augmented data, and/or synthetic data provided for training an electronic model and/or testing data (e.g., testing data W (197)) for validating the accuracy of a trained model. Input training parameters may be specified parameters for an electronic model, such as number of hidden layers, types of hidden layers (e.g., convolution layers, pooling layers, downsampling layers, upsampling layers), types of input features and/or output classes, type of activation functions, etc. An electronic model selection may be a specified type of electronic model, such as a deep neural network, a recurrent neural network, a transformer, a natural language processing model, a computer vision model, etc. A distribution algorithm selection may correspond to a type of resource distribution in a distributed training network for training operations, such as data parallelism, model parallelism, pipeline parallelism, etc. A machine learning algorithm selection may include types of optimizer functions, types of loss functions, whether to use synthetic gradient algorithm or a backward propagation algorithm, etc.

Keeping with the training manager, a training manager may provide a user interface (e.g., user interface W (192)) for adjusting and/or monitoring training operations. For example, a training manager may obtain status reports (e.g., training status reports A (137)) from one or more distributed training networks (e.g., distributed training network B (105)) regarding progress of one or more training operations. Accordingly, a training manager may communicate with one or more user devices regarding status reports, e.g., regarding a completion time of a training operation. As such, a training manager may provide different functions distributed over multiple locations from a central server, which may be performed using one or more Internet connections. More specifically, the training manager may provide a cloud computing environment that operates according to one or more service models, such as deep learning as a service (DLaaS), infrastructure as a service (IaaS), platform as a service (PaaS), software as a service (SaaS), mobile “backend” as a service (MBaaS), serverless computing, and/or function as a service (FaaS).

While FIGS. 1 and 2 show various configurations of components, other configurations may be used without departing from the scope of the disclosure. For example, various components in FIGS. 1 and 2 may be combined to create a single component. As another example, the functionality performed by a single component may be performed by two or more components.

Turning to FIGS. 3A-3B, 4, and 5, FIGS. 3A-3B, 4, and 5 provide examples of various resource distributions in accordance with one or more embodiments. The following examples are for explanatory purposes only and not intended to limit the scope of the disclosed technology.

Turning to FIGS. 3A-3B, FIG. 3A shows a resource distribution D (300) based on a data parallelism configuration in accordance with one or more embodiments. In particular, a distributed training controller D (330) is coupled to several training nodes, i.e., training node E (351), training node F (352), training node G (353), and training node H (354), that include several SGPUs, i.e., SGPU E (311), SGPU F (312), SGPU G (313), and SGPU H (314). The distributed training controller D (330) is performing a training operation based on a training dataset D (340) that includes multiple batches of training data for different epochs, i.e., batch A (341), batch B (342), batch C (343), and batch D (344). Here, a copy of a complete electronic model D (390) is stored on each of the training nodes (351, 352, 353, 354) so that the SGPUs (311, 312, 313, 314) may determine different portions of a synthetic gradient update based on different sub-batches of data. In other words, for current epoch (371), a respective SGPU may access the current version of the complete electronic model D (390) to determine a portion of the synthetic gradients values for updating the entire machine learning model. Thus, the SGPU E (311) may determine synthetic gradients E (321) based on sub-batch data E (345) and using the complete electronic model D (390). Likewise, the SGPUs (312, 313, 314) determine synthetic gradients F (322), synthetic gradients G (323), and synthetic gradients H (324) based on sub-batch data F (346), sub-batch data G (347), and sub-batch data H (348), respectively.

In FIG. 3B, the synthetic gradients (321, 322, 323, 324) are provided by the training nodes (351, 352, 353, 354) for determining a model update of the complete electronic model D (390) to produce an updated electronic model D (391). For a centralized architecture, the distributed training controller D (330) may collect the synthetic gradients (321, 322, 323, 324). For a decentralized architecture, the training nodes (351, 352, 353, 354) may exchange the synthetic gradients (321, 322, 323, 324) among each other to locally update their version of the complete electronic model D (390)

Turning to FIG. 4, FIG. 4 shows a resource distribution M (400) based on a model parallelism configuration in accordance with one or more embodiments. Similar to FIGS. 3A-3B, a distributed training controller M (430) is coupled to several training nodes, i.e., training node E (451), training node F (452), training node G (453), and training node H (454), that include several SGPUs, i.e., SGPU E (411), SGPU F (412), SGPU G (413), and SGPU H (414). Likewise, the resource distribution M (400) is for a training operation based on a training dataset M (440) that includes multiple batches of training data for different epochs, i.e., batch A (441), batch B (442), batch C (443), and batch D (444). However, unlike in FIGS. 3A-3B, only a portion of a complete electronic model M (490) is stored on each of the training nodes (451, 452, 453, 454). As shown in FIG. 4, a subset model E (491), a subset model F (492), a subset model G (493), and a subset model H (494) are disposed respectively on the training nodes (451, 452, 453, 454). Thus, the SGPUs (411, 412, 413, 414) may determine different portions of a synthetic gradient update based on different portions of the complete electronic model M (490). For current epoch (471), a respective training node may communicate model values and synthetic gradient values for computing a complete model update.

Turning to FIG. 5, FIG. 5 shows a resource distribution P (500) based on a pipeline parallelism configuration in accordance with one or more embodiments. Here, a pipeline queue P (580) manages an order that various sub-batches (i.e., sub-batch data A (581), sub-batch data B (582), sub-batch data C (583), sub-batch data D (584), sub-batch data E (585), sub-batch date F (586), sub-batch data G (587), and sub-batch data H (588)) are transmitted into a training operation pipeline. As shown, the resource distribution P (500) is divided four stages, i.e., stage M (511), stage N (512), stage O (513), and stage P (514). As shown in FIG. 5, stage M (511) includes a training node M (531) that includes GPU M (521) and SGPU P (524). Thus, the training node M (531) obtains the next sub-batch, i.e., sub-batch data D (584), from the pipeline queue P (580), while transmitting a stage M output (593) based on sub-batch data C (583). With respect to stage N (512), stage N (512) includes a training node N (532) that is obtaining the stage M output (593), while transmitting its own intermediate output, i.e., stage N output (593) based on sub-batch data B (582). With respect to stage O (513), stage O (513) includes a training node O (533) that is obtaining the stage N output (592), while transmitting its own intermediate output, i.e., stage O output (592) based on sub-batch data A (581) to stage P (514). As such, stage P (514) includes a training node P (534) that further processes the sub-batch data in the training operation pipeline.

Turning to FIG. 6, FIG. 6 shows a flowchart in accordance with one or more embodiments. Specifically, FIG. 6 describes a method for training an electronic model. One or more blocks in FIG. 6 may be performed by one or more components (e.g., distributed training controller B (130)) as described in FIGS. 1 and/or 2. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, a request is obtained to train an electronic model using various training nodes including one or more SGPUs in accordance with one or more embodiments. For example, a user device may communicate with a training manager through a graphical user device. Based on inputs from the user device, the training manager may transmit a request to a distributed training controller to initiate a training operation.

In Block 610, training data are obtained for an electronic model in accordance with one or more embodiments. For example, training data may be prepared by a user for use in a particular training operation. Likewise, in some embodiments, a training manager may also generate training data, e.g., using a synthetic data generation process or by augmenting acquired training data.

With respect to electronic models, an electronic model may be a deep neural network that includes three or more hidden layers, where a hidden layer includes at least one neuron. A neuron may be a modelling node that is loosely patterned on a neuron of the human brain. As such, a neuron may combine data inputs with a set of coefficients, i.e., a set of weights, for adjusting the data inputs transmitted through the model. These weights may amplify or reduce the value of a particular data input, thereby assigning an amount of significance to data inputs passing between hidden layers. Through machine learning, a neural network may determine which data inputs should receive greater priority in determining a specified output of the neural network. Likewise, these weighted data inputs may be summed such that this sum is communicated through a neuron's activation function (e.g., a sigmoid function) to other hidden layers within the neural network. As such, the activation function may determine whether and to what extent an output of a neuron progresses to other neurons in the model. Likewise, the output of a neuron may be weighted again for use as an input to the next hidden layer.

Furthermore, an electronic model may be trained using various machine learning algorithms. For example, various types of machine learning algorithms may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the electronic model.

In some embodiments, the weights of an electronic model are quantized weights. Quantized weights may include values constrained to a discrete set. In some embodiments, quantized weights are binarized weights. For example, binarized weights may include the values ‘+1’, and ‘−1’.For example, binarization may be performed using a deterministic approach or a stochastic approach. In the deterministic approach, parameters within a model may be binarized using a sign function, where values equal or greater than an entry position are designated one value, e.g., ‘+1’, and all other values are designated a different value, e.g., ‘−1’. In a stochastic approach, weights may be binarized using a sigmoid function. In some embodiments, weights in an electronic model are ternarized weights. For example, ternarized weights may include the values ‘+1’, ‘0’, and ‘−1’, and where data is ternarized using a threshold function. For example, a threshold function may have a tunable threshold value, where data above the positive threshold value is ‘+1’, data below the negative threshold value is ‘−1’, and data with an absolute value between the positive and negative threshold values is ‘0’. A real valued copy of a model's weights may be stored in a copy of an electronic model, where the binary weights are updated during a training iteration and the updated weights are binarized again.

In some embodiments, the electronic model is a transformer. For example, a transformer may include multiple encoders and multiple decoders for performing natural language processing (NLP). However, transformers may also be used as computer vision models in some embodiments. In some embodiments, the transformer may only include encoders or decoders. An encoder may include a feed forward neural network and a self-attention layer, which may be both updated using synthetic gradients. Likewise, a decoder may include a self-attention layer, an encoder-decoder attention layer, as well as a feed forward neural network. Thus, the various neural networks within a transformer may be updated using one or more SGPUs in a training operation.

In Block 620, a resource distribution is determined for various training nodes based on a distribution algorithm and an electronic model in accordance with one or more embodiments. The resource distribution may be similar to the resources distributions describes above in FIGS. 1, 3A, 3B, 4, and 5 and the accompanying description.

In Block 630, a trained model is generated using an electronic model, training data, various training nodes, a machine learning algorithm, and various synthetic gradients in accordance with one or more embodiments. For example, an electronic model may be trained using synthetic gradients generated by one or more SGPUs disposed in one or more training nodes. For more information on training, see the section below titled Synthetic Gradient Processing as well as FIG. 1 above and the accompanying description.

In Block 640, a trained model is provided for one or more inference operations in accordance with one or more embodiments. Once an electronic model is trained and validated, the resulting training model may be provided to a user. For example, the trained model may be transmitted to a server, where the trained model may be used in production. For example, a trained model may be used to perform one or more inference operations, where data may be predicted based on one or more input features.

### Synthetic Gradient Processing

In general, embodiments of the disclosure include systems and methods for using machine learning algorithms to generate an electronic model. In particular, some embodiments are directed toward using an optical system in order to determine synthetic gradients for an electronic model update. The optical system may include a medium tailored to a specific synthetic gradient computation. In some embodiments, the medium may be a diffusive medium or an engineered medium. For example, where an electronic model fails to accurately predict a real-world application, error data based on the difference between predicted data and real-world data may form the basis of an input vector to an optical system coupled to a medium. Where a computer may individually determine updated weights within a machine learning model, a speckle field value of a medium may provide a relatively fast process for determining synthetic gradients for multiple hidden layers within a deep neural network. In other words, an optical system may provide a portion of the processing to determine synthetic gradients within a machine learning algorithm, while a controller may perform the remaining portion of the synthetic gradient generation, e.g., using Fourier transforms and other techniques to determine the complex-valued speckle field. In some embodiments, for example, the machine learning algorithm is a direct feedback alignment algorithm.

In some embodiments, the speckle field is determined by an optical image that is obtained by an optical detector in an optical system responsible for a portion of the synthetic gradient computation. For example, an optical image may record a combined optical signal obtained by mixing a reference optical signal and a resulting optical signal output from a medium. More specifically, a linear mixing of real and imaginary components of an optical signal may occur during transmission through a medium. As such, the optical image may provide a matrix multiplication sufficient for generating synthetic gradients for various hidden layers within an electronic model after further processing of the optical data by a controller. For example, the matrix multiplication may be a multiplication by a fixed random matrix or by an arbitrary matrix where an engineered medium is used.

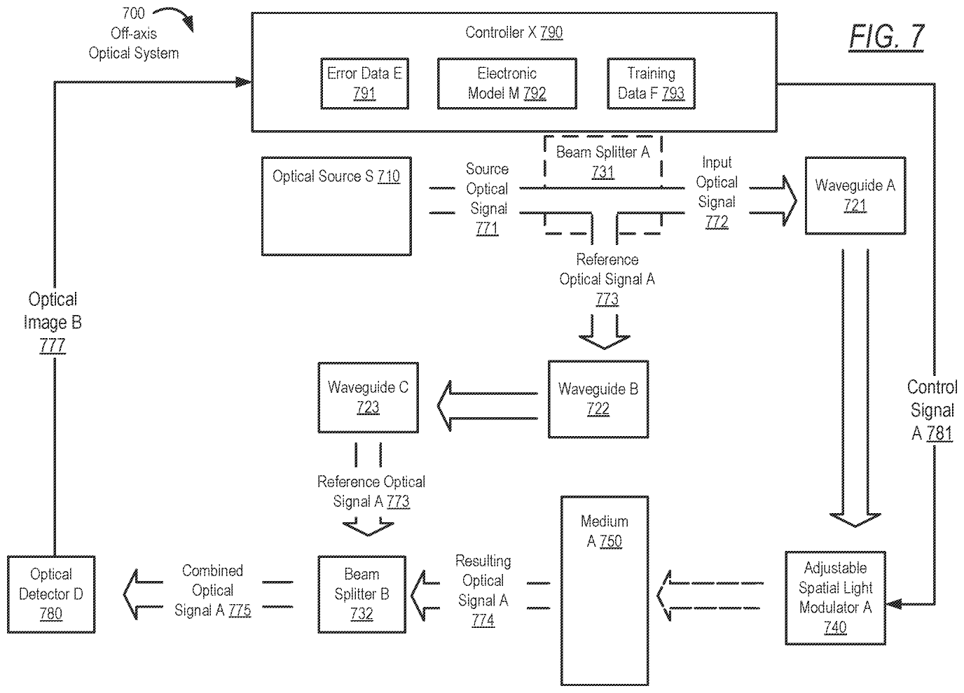

Turning to FIG. 7, FIG. 7 shows a schematic diagram in accordance with one or more embodiments. As shown in FIG. 7, FIG. 7 illustrates an off-axis optical system (700) that may include an optical source (e.g., optical source S (710)) coupled to an adjustable spatial light modulator (e.g., adjustable spatial light modulator A (740)), an optical detector (e.g., optical detector D (780)), and various beam splitters (e.g., beam splitter A (731), beam splitter B (732)). For example, the optical source may be a coherent light source such as a laser device. More specifically, the optical source may include hardware with functionality for generating a continuous wave (CW) signal, e.g., an optical signal that is not pulsed. In some embodiments, the adjustable spatial light modulator is a digital micromirror device (DMD). Furthermore, other technologies like liquid crystal on silicon (LCoS) or electro-absorption modulators are also contemplated for the adjustable spatial light modulator. In some embodiments, a single frequency optical source is used, but other embodiments are contemplated that use multiple optical wavelengths.

The optical detector may be a camera device that includes hardware and/or software to record an optical signal at one or more optical wavelengths. For example, the optical detector may include an array of complementary metal-oxide-semiconductor (CMOS) sensors. Thus, the optical detector may include hardware with functionality for recording the intensity of an optical signal. The beam splitters may include hardware with functionality for splitting an incident optical signal into two separate output optical signals (e.g., beam splitter A (731) divides optical source signal (771) into an input optical signal (772) and a reference optical signal A (773)). A beam splitter may also include functionality for combining two separate input optical signals into a single combined optical signal (e.g., combined optical signal A (775)). In some embodiments, a beam splitter may be a polarizing beam splitter that separates an unpolarized optical signal into two polarized signals. Thus, the system may include a polarizer coupled to the optical detector.

In some embodiments, an off-axis optical system includes functionality for generating a reference optical signal (e.g., reference optical signal A (773)) (also called “reference beam”) and an input optical signal (e.g., input optical signal (772)) (also called “signal beam”) using a source optical signal (e.g., source optical signal (771)). As shown in FIG. 7, for example, the input optical signal (772) is transmitted through a medium A (750) at a particular light modulation to produce a resulting optical signal A (774). At beam splitter B (732), the reference optical signal A (773) is combined with the resulting optical signal A (774) to generate a combined optical signal A (775). As such, the optical detector D (780) receives the combined optical signal A (775) for further processing, e.g., to generate an optical image B (777) that is analyzed to determine a speckle field of the medium A (750). Accordingly, the off-axis optical system (700) provides an optical system for determining synthetic gradients for updating an electronic model (e.g., electronic model M (792)) during a machine learning algorithm.

In some embodiments, a medium may be a disordered or random physical medium that is used for computing values in a random matrix. Examples of a medium include translucent materials, amorphous materials such as paint pigments, amorphous layers deposited on glass, scattering impurities embedded in transparent matrices, nano-patterned materials and polymers. An example of such a medium is a layer of an amorphous material such as a layer of Zinc-oxide (ZnO) on a substrate. In some embodiments, a medium may be engineered to implement a specific transform of the light field. Examples of an engineered medium may include phase masks manufactured using a lithography technique. More specifically, the engineered medium may be an electronic device that includes various electrical properties detectable by optical waves. Example of such electronic devices may include LCoS spatial light modulators. In some embodiments, multiple media may be combined together to implement a series of transformations of the light field.

In some embodiments, an adjustable spatial light modulator includes functionality for transmitting an input optical signal through a medium (e.g., medium A (750)) at a predetermined light modulation. More specifically, the adjustable spatial light modular may include hardware/software with functionality to spatially modulate an input optical signal in two-dimensions based on input information. For example, according to the input information, the adjustable spatial light modulator may change the spatial distribution of the input optical signal in regard to phase, polarization state, intensity amplitude, and/or propagation direction. In some embodiments, an adjustable spatial light modulator performs binary adjustments, such that a portion of the input optical signal at a particular location is transmitted to the medium either with a light modulation change or without such a change. In some embodiments, an adjustable spatial light modulator modifies a portion of an input optical signal with a range of values, e.g., various grey levels of light modulation.

Furthermore, the output of an adjustable spatial light modulator may be transmitted through a medium with a predetermined light modulation as specified by an input vector (e.g., a control signal A (781) based on error data E (791)). When the input optical signal is transmitted through the medium (e.g., medium A (750)), the input optical signal may undergo various optical interferences, which may be analyzed in a resulting optical signal output from the medium. In some embodiments, the propagation of coherent light through a medium may be modeled by the following equation:

y=Hx Equation 1

where H is a transmission matrix of the medium, x is an input optical signal, and y is the resulting optical signal. Moreover, the transmission matrix H may include complex values with real components and imaginary components. For a diffusive medium, these components may be arranged according to a Gaussian distribution. More specifically, a speckle field of the medium may interfere with an input optical signal such that an optical detector records an image illustrating a modulated speckle pattern. Thus, the image may be processed to extract values of a speckle field. For more information on processing an optical image, see Blocks 460 and 465 in FIG. 4 below and the accompanying description.

In some embodiments, a controller (e.g., controller X (790)) is coupled to an optical detector and an adjustable spatial light modulator. In particular, a controller may include hardware and/or software to acquire output optical data from an optical detector to train an electronic model (e.g., electronic model M (792)). More specifically, the electronic model may be a machine learning model that is trained using various synthetic gradients based on output optical data (e.g., optical image B (777)), error data (e.g., error data E (791)) and a machine learning algorithm. The controller X (790) may determine error data E (791) that describes the difference between training data F (793) and predicted model data that is generated by the electronic model M (792). Likewise, an electronic model may predict data for many types of artificial intelligence applications, such as reservoir modeling, automated motor vehicles, medical diagnostics, etc. Furthermore, the electronic model may be using training data as an input for the machine learning algorithm. Training data may include real data acquired for an artificial intelligence application, as well as augmented data and/or artificially-generated data.

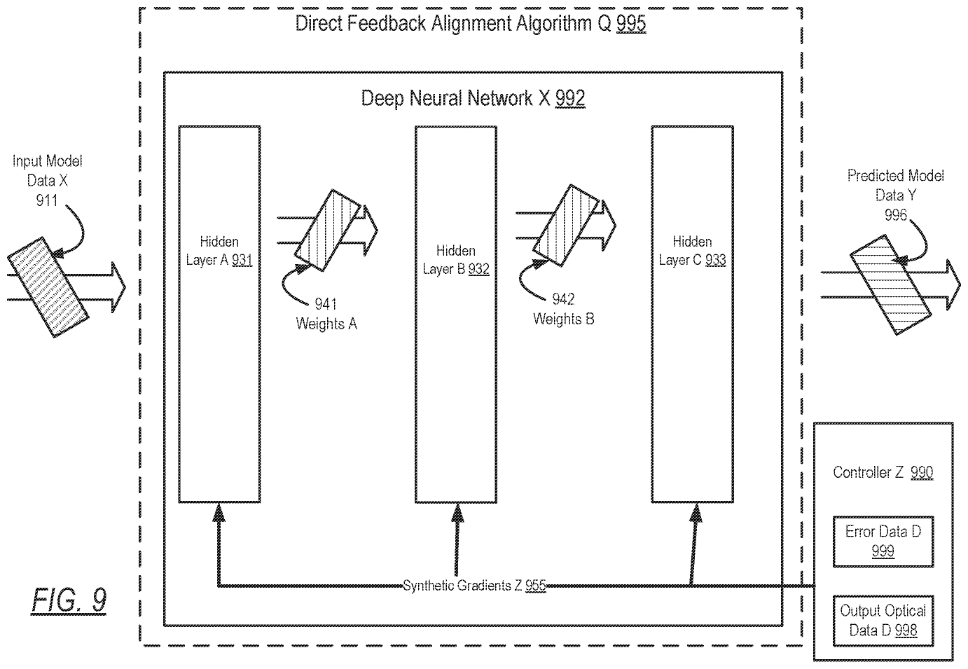

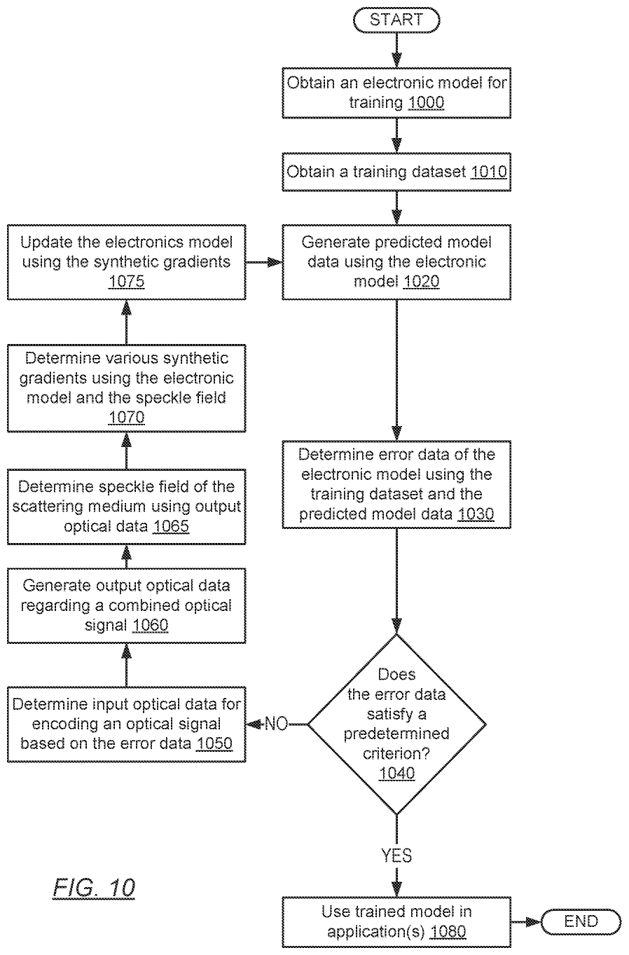

In some embodiments, the electronic model is a deep neural network and the machine learning algorithm is a direct feedback alignment algorithm. For more information on machine learning models, see FIGS. 9 and 10 below and the accompanying description. Examples of controllers may include an application specific integrated circuit (ASIC), a field programmable gate array (FPGA), a printed circuit board, or a personal computer capable of running an operating system. Likewise, the controller may be a computing system similar to computing system (600) described below in FIG. 6 and the accompanying description.

Keeping with the controller, the controller may include functionality for transmitting one or more control signals to manage one or more components within an off-axis optical system (e.g., optical source S (710), adjustable spatial light modulator A (740)). In some embodiments, for example, a controller may use a control signal (e.g., control signal A (781)) to determine a light modulation of an input optical signal (772) is transmitted through a medium. For a binary control signal, a high voltage value may trigger one light modulation value of an input optical signal, while a low voltage value may trigger a different light modulation angle. Thus, by using a control signal to manage the light modulation, a controller may implement an input vector to produce different types of optical images for use in updating an electronic model. For example, an optical detector may acquire an image frame that corresponds to an optical treatment of the input vector by an optical system. The image frame may then be post-processed to extract a linear matrix multiplication of the input vector. Multiple image frames and optical signal passes for a single input vector may be used by an off-axis optical system to determine the linear random projection and thus generate synthetic gradients.

In some embodiments, an off-axis optical system may include one or more waveguides (e.g., waveguide A (721), waveguide B (722), waveguide C (723)) to manage the transmission of optical signals (e.g., reference optical signal A (773), input optical signal (772)). For example, the waveguides (722, 123) may direct the reference optical signal A (773) through the off-axis optical system (700) to the beam splitter B (732). Waveguides may include various optical structures that guide electromagnetic waves in the optical spectrum to different locations within an optical system, such as a photonic integrated circuit. For example, optical waveguides may include optical fibers, dielectric waveguides, spatial light modulators, micromirrors, interferometer arms, etc. In some embodiments, an off-axis optical system uses free-space in place of one or more waveguide components. For example, a reference optical signal A (773) may be transmitted from beam splitter A (731) to beam splitter B (732) through air.

In some embodiments, the off-axis optical system (700) includes an interferometer. For example, waveguide A (721) may be an interferometer arm that transmits the input optical signal (772) and the subsequent resulting optical signal A (774) to beam splitter B (732). As such, the medium may be disposed inside this interferometer arm. Likewise, the waveguides (722, 123) may be another interferometer arm for transmitting the reference optical signal A (773) from beam splitter A (731) to beam splitter B (732). Where the off-axis optical system is implemented with interferometry, the overall optical system may be sufficiently stable and configured with optical signals having a wavelength of 532 nm.

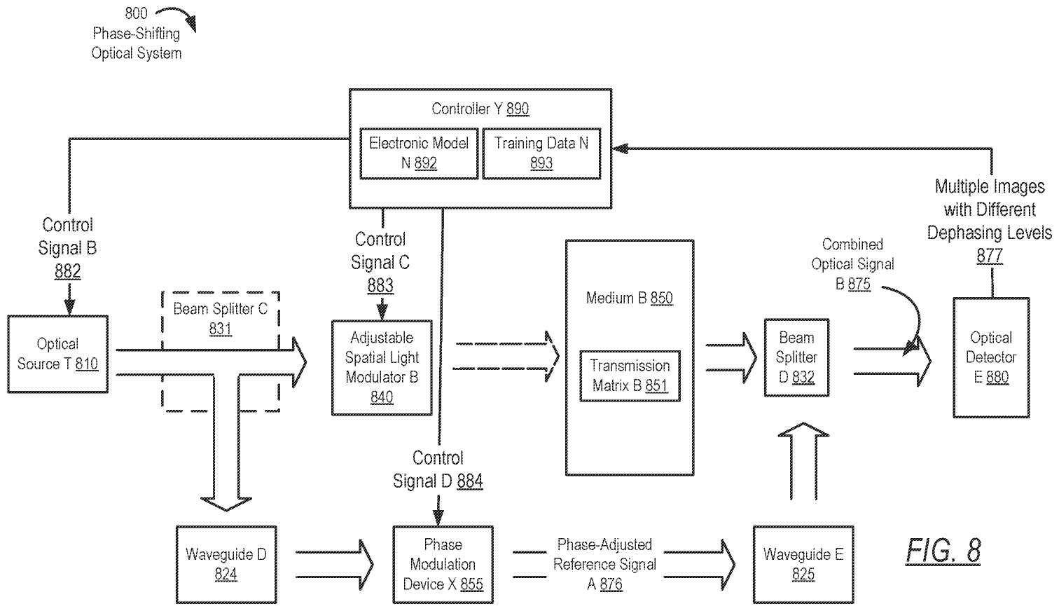

Turning to FIG. 8, FIG. 8 shows a schematic diagram in accordance with one or more embodiments. As shown in FIG. 8, FIG. 8 illustrates a phase-shifting optical system (800) that may include an optical source (e.g., optical source T (810)), an adjustable spatial light modulator (e.g., adjustable spatial light modulator B (840)), an optical detector (e.g., optical detector E (880)), various beam splitters (e.g., beam splitter C (831), beam splitter D (832)), various waveguides (e.g., waveguide D (824), waveguide E (825)), a medium (e.g., medium B (850) with a transmission matrix B (851)), and a controller (e.g., controller Y (890)). A controller may transmit various control signals to various components (e.g., control signal B (882), control signal C (883), control signal D (884)) in order to manage one or more parameters of the phase-shifting optical system for generating synthetic gradients. Similar to the off-axis optical system (700) in FIG. 7, a phase-shifting optical system may generate a combined optical signal (e.g., combined optical signal B (875)) based on a reference signal (e.g., phase-adjusted reference signal A (876)) and a resulting optical signal output from a medium (e.g., medium B (850)). Furthermore, an optical detector may produce output optical data (e.g., multiple images with different dephasing levels (877)) to train an electronic model (e.g., electronic model N (892)) using training data (e.g., training data N (893)). More specifically, one or more components or technologies implemented using a phase-shifting optical system may be similar components and/or technologies described above with respect the off-axis optical system in FIG. 7 and the accompanying description.

In some embodiments, a phase-shifting optical system includes a phase modulation device (e.g., phase modulation device X (855)). In particular, a phase modulation device may include hardware/software with functionality for phase-shifting an optical signal by a predetermined amount. Example phase-modulation devices may include a liquid crystal device, an electro-optical modulator, or a device using various piezo-crystals to implement phase-shifting. As shown in FIG. 8, a phase modulation device may receive a control signal (e.g., control signal D (884)) from a controller to produce various phase-adjusted reference signals (e.g., phase-adjusted reference signal A (876)).

In some embodiments, a medium's full field is obtained from multiple images with different dephasing levels of a reference optical signal. In particular, optical data post-processing may include a simple linear combination from multiple images. For example, two images with different dephasing level may be used by a controller to determine an imaginary component of a combined optical signal. To determine both the imaginary component and the real component of a combined optical signal, three images with different dephasing may be used.

The systems described in FIG. 7 and FIG. 8 may leverage a medium's transmission matrix to perform a large matrix multiplication required by an electronic model. In some embodiments, the electronic model may be a machine learning algorithm. The machine learning algorithm may have applications in reservoir computing, random kernel processing, extreme machine learning, differential privacy, etc. A system with a disordered medium may be used to perform random projections. For example, in a reservoir computing algorithm the medium transmission matrix may act as the reservoir. The reservoir computing algorithm may be used to predict the behavior of a chaotic physical system, such as predicting future weather patterns. Or, in an algorithm that processes data with a kernel, the kernel may be approximated using random features produced by the system. For example, the kernel may be used in a diffusion map, to generate a representation of the dynamics of a drug molecule. Likewise, in an algorithm implementing differential privacy, an embedding of a sensitive data sample may be generated using the system to ensure the data sample remains private. The differential privacy algorithm may be used to process sensitive data such as health data, geolocation data, etc. In some embodiments, the electronic model may be used to process a database including high-dimensional data. The system may be used to generate hashes of the item in the database, to help access and process them faster. For example, an algorithm may be a locally sensitive hashing algorithm, using the system to perform random projections that preserve the distance between entries in the database. In some embodiments, the electronic model may process continuous streams of data, and implement an online learning algorithm. For example, the system may be used to generate a sketch of an acquired data sample and the algorithm may use the sketch to perform change-point detection. The change-point detection algorithm may be used to detect anomalies in streams of financial transactions, streams of industrial sensors, remote sensing images, etc. In some embodiments, the electronic model may be a randomized linear algebra algorithm. For example, the system may be used to randomly precondition matrices before applying a singular value decomposition algorithm. The singular value decomposition obtained after preconditioning may be used in a recommender system, for example to suggest an ad to display, or content to watch.

Turning to FIG. 9, FIG. 9 illustrates an electronic model in accordance with one or more embodiments. As shown in FIG. 9, FIG. 9 illustrates an electronic model (e.g., deep neural network X (992)) that is trained using a machine learning algorithm (e.g., direct feedback alignment algorithm Q (995)) and various inputs (e.g., input model data X (911)). For example, a deep neural network X (992) generates predicted model data Y (996) in response to input model data X (911). Thus, a controller Z (990) may determine error data D (999) using an error function that computes the difference between the predicted model data Y (996) and training data for a particular application. In some embodiments, this error function may be a root mean square function, or a cross-entropy function. In other embodiments, the error function may compare data obtained at intermediary steps in the neural network and the training data. Or, the error function may also only use the mathematical properties of the predicted model data. Using the error data D (999), the controller Z (990) may obtain output optical data D (998) from an optical detector in an off-axis optical system or a phase-shifting optical system. Using the output optical data D (998), the controller Z (990) may determine a speckle field accordingly in which to calculate the synthetic gradients Z (955). Thus, output optical data D (998) may be obtained for multiple error values for various training iterations, which may be referred to as machine learning batches. An ensemble of such training iterations covering the entire training data may be referred to as machine learning epochs. In each training iteration, different error values may correspond to different values of synthetic gradients.

While FIGS. 7, 8, and 9 show various configurations of components, other configurations may be used without departing from the scope of the disclosure. For example, various components in FIGS. 7, 8, and 9 may be combined to create a single component. As another example, the functionality performed by a single component may be performed by two or more components.

Turning to FIG. 10, FIG. 10 shows a flowchart in accordance with one or more embodiments. Specifically, FIG. 10 describes a method for training an electronic model and/or using a trained model. One or more blocks in FIG. 10 may be performed by one or more components (e.g., controller X (790)) as described in FIGS. 7, 8, and/or 9. While the various blocks in FIG. 10 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 1000, an electronic model is obtained for training in accordance with one or more embodiments. For example, the electronic model may be a machine learning model that is capable of approximating solutions of complex non-linear problems, such as a deep neural network X (992) described above in FIG. 9 and the accompanying description. Likewise, the electronic model may be initialized with weights and/or biases prior to training.

In Block 1010, a training dataset is obtained in accordance with one or more embodiments. For example, a training dataset may be divided into multiple batches for multiple epochs. Thus, an electronic model may be trained iteratively using epochs until the electronic model achieves a predetermined level of accuracy in predicting data for a desired application. One iteration of the electronic model may correspond to Blocks 1020-1075 below in FIG. 10 and the accompanying description. Better training of the electronic model may lead to better predictions using the model. Once the training data is passed through all of the epochs and the model is further updated based on the model's predictions in each epoch, a trained model may be the final result of a machine learning algorithm, e.g., in Block 1080 below. In some embodiments, multiple trained models are compared and the best trained model is selected accordingly. In other embodiments, the predictions of multiple trained models may be combined using an ensembling function to create a better prediction. This ensembling function may be tuned during the training process. In some embodiments, the multiple considered models may all be trained in parallel using a single optical system. Likewise, different portions of the training data may be used as batches to train the model and determine error data regarding the model.

In Block 1020, predicted model data is generated using an electronic model in accordance with one or more embodiments. In particular, based a set of input model data, an electronic model may generate predicted output model data for comparison with real output data. For a medical diagnostic example, a patient's data may include various patient factors, such as age, gender, ethnicity, and behavioral considerations in addition to various diagnostic data, such as results of blood tests, magnetic-resonance imaging (MRI) scans, glucose levels, etc. that may serve as inputs to an electronic model. For a predicting a specific medical condition such as a cancer diagnosis, one or more of these inputs may be used by the electronic model with machine learning to predict whether the patient has a particular medical condition. Here, a prediction regarding a patient's medical condition, i.e., predicted model data, may be compared to whether the actual patients was confirmed to have the particular medical condition, i.e., acquired data for verifying the electronic model's accuracy.

In Block 1030, error data of an electronic model is determined using a training dataset and predicted model data in accordance with one or more embodiments. Based on the difference between predicted model data and training data, weights and biases within the electronic model may need to be updated accordingly. More specifically, the error data may be determined using an error function similar to the error function described above in FIG. 9 and the accompanying description. Likewise, where the error data identifies the electronic model as lacking a desired level of accuracy, the error data may be used by an optical system (e.g., off-axis optical system (700) or phase-shifting optical system) to compute synthetic gradients for updating the electronic model.

In Block 1040, a determination is made whether the error data satisfies a predetermined criterion in accordance with one or more embodiments. For example, the criterion may be a predetermined threshold based on the difference between real acquired data and the predicted model data. Likewise, a controller may determine whether the difference has converged to a minimum value, i.e., a predetermined criterion. When a determination is made that no further machine learning epochs are required for training the electronic model, the process may proceed to Block 1080. When a determination is made that the electronic model should be updated, the process may return to Block 1050.

In Block 1050, input optical data is determined for encoding an optical signal based on error data in accordance with one or more embodiments. Using error data regarding an electronic model, input optical data may be determined that corresponds to a control signal for an adjustable spatial light modulator. For example, the input optical data may specify a particular light modulation with respect to a current error value between predicted model data and acquired real data.

In Block 1060, output optical data regarding a combined optical signal is generated in accordance with one or more embodiments. For example, the output optical data may be similar to optical image B (777) acquired from the off-axis optical system (700) in FIG. 7 or multiple images with different dephasing levels (877) acquired from the phase-shifting optical system (800) in FIG. 8. Likewise, the combined optical signal may be similar to combined optical signal A (775) or combined optical signal B (875) described above in FIGS. 7 and 8, respectively, and the accompanying description.

In Block 1065, output optical data is processed to determine a speckle field of a medium in accordance with one or more embodiments. In particular, a controller may determine a linear random projection of an input optical signal using such processing techniques. For example, a resulting optical signal at a predetermined light modulation may result in a fringed speckle pattern when transmitted through a medium. Thus, an optical image with the fringed speckle pattern may be processed to determine a speckle field and/or the full field of an optical signal.

In some embodiments, a speckle field is determined using Fourier transform processing. More specifically, a combined optical signal generated by an off-axis optical system or a phase-shifting optical system may be the sum of a resulting optical signal and a reference optical signal. Thus, if the intensities of both optical signals were recorded individually and then processed numerically, the summation may approximate the intensity of the combined optical signal. As such, a linear phase shift in the spatial domain may correspond to a translation in the Fourier space. In other words, a Fourier transform may enable a separation of a speckle field from the combined optical signal. In particular, by tuning the incident angle on the camera between the resulting optical signal and the reference optical signal, the speckle field may be isolated from other components within a combined optical signal. This tuning may be performed only once, when the system is first calibrated.

To recover a phase value of each pixel of an optical image, the linear component of the Fourier transform may be isolated in the Fourier space. As such, an inverse Fourier transform to complete the phase retrieval post-processing may be performed in some embodiments. In another embodiment, an inverse Fourier transform is not performed as the Fourier transform may produce a linear random projection from an optical image that is sufficient to determine synthetic gradients for updating an electronic model at Block 1075 below.

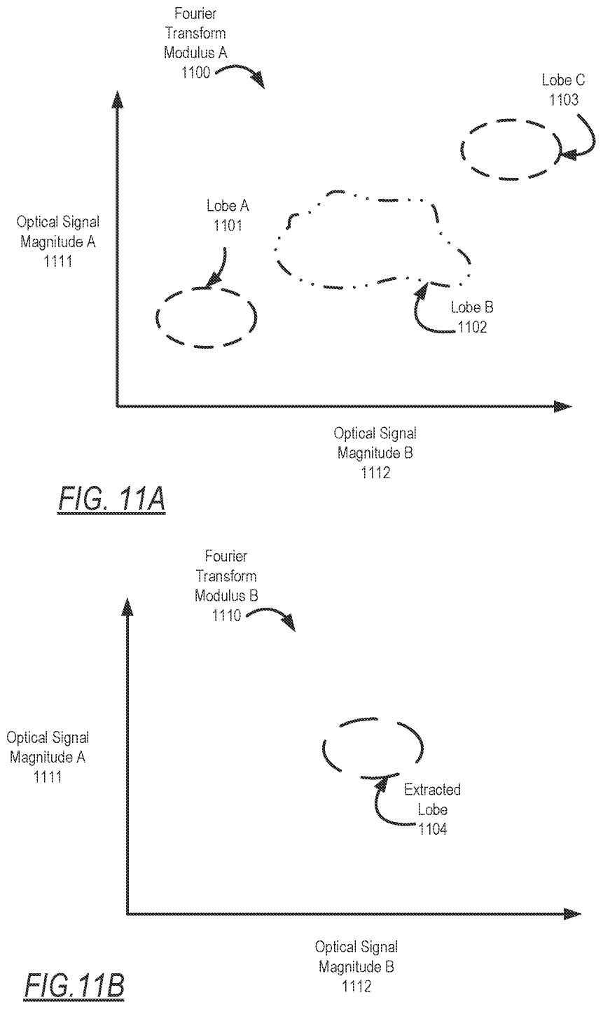

Turning to FIGS. 11A and 11B, FIGS. 11A and 11B provide an example of

Fourier transform processing using an adjustable spatial light modulator. The following example is for explanatory purposes only and not intended to limit the scope of the disclosed technology.

In FIG. 11A, a Fourier Transform Modulus A (1100) is generated based on a measured intensity of an optical signal by an optical detector. In particular, the optical signal's intensity is recorded in an optical image with vertical and horizontal axes. The magnitude of the Fourier transform of the recorded optical signal in the vertical axis is the optical signal magnitude A (1111). Likewise, the magnitude of the Fourier transform of the recorded optical signal in the horizontal axis is the optical signal magnitude B (1112). As shown in FIG. 11A, three components of the Fourier transform of the recorded optical signal are illustrated, i.e., lobe A (1101), lobe B (1102), and lobe C (1103). In this example, lobe B (1102) corresponds to an incoherent sum of a resulting optical signal and a reference optical signal. Likewise, lobe A (1101) and lobe C (1103) correspond to phase and amplitude information of a speckle field produced by a medium. Lobe A (1101), lobe B (1102), lobe C (1103) are separated by using a quantitative value determined for a tilt of a reference optical signal. In FIG. 11B, an extracted lobe (1104) is obtained by isolating either lobe A (1101) or lobe C (1103) to produce a lobe proportional to a speckle field of a medium. As lobe A (1101) and lobe C (1103) are symmetric in the Fourier field and thus include the same information, they may be used interchangeably. Accordingly, an inverse Fourier transform on the Fourier Transform Modulus B (1110) retrieves the speckle field. If a different input optical signal is used, some further calculations may be performed to determine the speckle field from the optical image.

Returning to Block 1065, in some embodiments, a speckle field for a medium is determined using combining fields quadratures processing. Where Fourier transforms may be inefficient for complex optical computations, combining fields quadratures processing may provide simpler calculations for a controller to determine a speckle field. In particular, a tilt of an optical signal may be adapted, such that the phase of the optical signal varies by a predetermine phase (e.g., π/2) from one pixel to the following pixel within an optical image. Accordingly, by tuning a reference optical signal's phase shift, the speckle field may be calculated accordingly using only linear combinations.

In some embodiments, a speckle field for a medium is determined using a subtraction technique based on a high intensity reference path. For example, an intensity of an input optical signal may be separately acquired. By setting the intensity of an input optical signal to be much greater than the speckle field component, the input optical signal's intensity may be subtracted from the recorded optical image. The subtracted value may then be used to determine the speckle field.

In Block 1070, various synthetic gradients are determined using an electronic model and a speckle field in accordance with one or more embodiments. Synthetics gradients may be generated in a similar manner as the synthetic gradients described above in FIG. 9 and the accompanying description.

In Block 1075, an electronic model is updated using various synthetic gradients in accordance with one or more embodiments. In particular, the synthetic gradients may adjust various weights through the electronic model for another error function calculation to verify the accuracy of the electronic model.

In Block 1080, a trained model is used in one or more applications in accordance with one or more embodiments. For example, trained models may be used to predict data in image recognition tasks, natural language processing workflows, recommender systems, graph processing, etc.

In some embodiments, for example, the process described in FIG. 10 may be integrated into a simulator for analyzing very large datasets, such as a seismic survey of a subterranean formation. Likewise, a controller coupled to an optical system described above in FIGS. 7-10 may be integrated into a motor vehicle, an aircraft, a cloud server, and many other devices that may require fast processing of a very large dataset to update and/or generate a machine learning model. In some embodiments, the process may be integrated in a computer vision workflow, such as a facial recognition system, or a self-driving vehicle vision system. Similarly, the process may be used to update a natural language processing model. The model may rely on an attention mechanism, arranged in transformer layers. For example, the model may be used to translate text from a language to another, to embed natural language instructions in a machine-understandable format, or to generate text from a user-defined prompt. These applications may be combined together in the setting of a smart assistant, or of an automated support system. Likewise, the process may be used to update a graph-processing model. The graph processing-model may generate molecular fingerprints to represent complex chemical structures such as drugs, to analyze communities and process social interactions, to iteratively learn combinatorial problems, or to analyze intricate organized structures such as DNA. In some embodiments, the process may be used to update in real-time recommender systems, such as an ad serving system.

### Computing System

Embodiments may be implemented on a computing system. Any combination of mobile, desktop, server, router, switch, embedded device, or other types of hardware may be used. For example, as shown in FIG. 12A, the computing system (1200) may include one or more computer processors (1202), non-persistent storage (1204) (e.g., volatile memory, such as random access memory (RAM), cache memory), persistent storage (1206) (e.g., a hard disk, an optical drive such as a compact disk (CD) drive or digital versatile disk (DVD) drive, a flash memory, etc.), a communication interface (1212) (e.g., Bluetooth interface, infrared interface, network interface, optical interface, etc.), and numerous other elements and functionalities.

The computer processor(s) (1202) may be an integrated circuit for processing instructions. For example, the computer processor(s) may be one or more cores or micro-cores of a processor. The computing system (1200) may also include one or more input devices (1210), such as a touchscreen, keyboard, mouse, microphone, touchpad, electronic pen, or any other type of input device.

The communication interface (1212) may include an integrated circuit for connecting the computing system (1200) to a network (not shown) (e.g., a local area network (LAN), a wide area network (WAN) such as the Internet, mobile network, or any other type of network) and/or to another device, such as another computing device.

Further, the computing system (1200) may include one or more output devices (1208), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (1202), non-persistent storage (1204), and persistent storage (1206). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (1200) in FIG. 12A may be connected to or be a part of a network. For example, as shown in FIG. 12B, a network system (1205) may include a network (1220) that may include multiple nodes (e.g., node X (1222), node Y (1224)). Each node may correspond to a computing system, such as the computing system shown in FIG. 12A, or a group of nodes combined may correspond to the computing system shown in FIG. 12A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (1200) may be located at a remote location and connected to the other elements over a network.

Although not shown in FIG. 12B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (1222), node Y (1224)) in the network (1220) may be configured to provide services for a client device (1226). For example, the nodes may be part of a cloud computing system. The nodes may include functionality to receive requests from the client device (1226) and transmit responses to the client device (1226). The client device (1226) may be a computing system, such as the computing system shown in FIG. 12A. Further, the client device (1226) may include and/or perform all or a portion of one or more embodiments of the disclosure.

The computing system or group of computing systems described in FIGS. 12A and 12B may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (1200) in FIG. 12A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 12A, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 12A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 12A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 12A and the nodes and/or client device in FIG. 12B. Other functions may be performed using one or more embodiments of the disclosure.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A system, comprising:
a plurality of training nodes comprising a first training node and a second training node, wherein the first training node comprises a synthetic gradient processing unit (SGPU), a plurality of processors, and at least one memory; and
a distributed training controller comprising a first processor and a first memory, the distributed training controller coupled to the plurality of training nodes and configured to:
determine, using a distribution algorithm, a resource distribution among the plurality of training nodes,
wherein the first training node trains an electronic model based on the resource distribution and parallel processing, and
transmit, to the first training node, the electronic model and training data, and
wherein the SGPU obtains an error data signal from at least one processor among the plurality of processors, and
wherein the electronic model is updated based on a synthetic gradient signal that is obtained from the SGPU in response to the error data signal.

2. The system of claim 1, wherein the first training node is configured to perform a direct feedback alignment (DFA) algorithm that comprises:
determining error data of the electronic model using the training data and predicted data that is generated by the electronic model;
obtaining, using the SGPU, a random projection of the error data;
determining a plurality of synthetic gradients based on the random projection of the error data, the electronic model, and the training data; and
updating the electronic model using the plurality of synthetic gradients.

3. The system of claim 1,
wherein the electronic model comprises an input layer, a plurality of hidden layers, and an output layer, and
wherein the first training node is configured to:
determine predicted data from a hidden layer among the plurality of hidden layers using first input data that is provided to the input layer of the electronic model or second input data that is provided by at least one previous hidden layer among the plurality of hidden layers to the hidden layer;
determine, using the SGPU, one or more local error values using a plurality of local loss functions, the training data, and the predicted data from the hidden layer;
determine, using the SGPU, a plurality of synthetic gradients based on the one or more local error values, the electronic model, and the training data; and
update the electronic model using the plurality of synthetic gradients.

4. The system of claim 1, wherein the SGPU comprises:
a second memory comprising a portion of the electronic model; and
an optical circuit comprising:
an adjustable spatial light modulator coupled to an optical source,
a medium coupled to the adjustable spatial light modulator, and
an optical detector coupled to the medium,
wherein the optical detector is configured to obtain a combined optical signal comprising a resulting optical signal that is produced by transmitting a first optical signal through the medium at a predetermined spatial light modulation using the adjustable spatial light modulator, and
wherein the combined optical signal further comprises a second optical signal from the optical source.

5. The system of claim 4, wherein the SGPU further comprises:
a controller coupled to the optical detector and the adjustable spatial light modulator,
wherein the resulting optical signal is generated based on the error data signal, and
wherein the synthetic gradient signal is based on the combined optical signal.

6. The system of claim 1, wherein the first training node comprises:
a graphical processing unit (GPU) comprising the plurality of processors and the at least one memory,
wherein the at least one memory comprises a device memory that comprises the electronic model, and
wherein the plurality of processors are parallel processors.

7. The system of claim 1,
wherein the resource distribution corresponds to a training operation using data parallelism, and
wherein the electronic model is a complete electronic model that is located on each training node among the plurality of training nodes.

8. The system of claim 1,
wherein the resource distribution corresponds to a training operation using model parallelism,
wherein the electronic model in the first training node is a subset model of a complete electronic model, and
wherein different portions of the complete electronic model are distributed among the plurality of training nodes.

9. The system of claim 1,
wherein the resource distribution corresponds to a training operation using pipeline parallelism, and
wherein the resource distribution divides a complete electronic model into a plurality of stages,
wherein the electronic model in the first training node corresponds to a plurality of consecutive layers of the complete electronic model,
wherein the resource distribution maps a first stage among the plurality of stages to the first training node, and
wherein the synthetic gradient signal is used to update the plurality of consecutive layers of the complete electronic model.

10. The system of claim 1,
wherein the SGPU is an application specific integrated circuit (ASIC), and
wherein the SGPU generates the synthetic gradient signal without using an optical circuit.

11. The system of claim 1, further comprising:
a node agent coupled to the SGPU and the plurality of processors,
wherein the node agent obtains the electronic model and the training data from the distributed training controller,
wherein the node agent distributes the training data among the plurality of processors based on the resource distribution, and
wherein the node agent transmits the electronic model to the SGPU and the plurality of processors.

12. The system of claim 1, further comprising:
a training manager coupled to distributed training controller and a user device,
wherein the training manager comprises a user interface, a second processor, and a second memory,
wherein the training manager is configured to obtain, from the user device, a distribution algorithm selection, an electronic model selection, and the training data, and
wherein the training manager is configured to provide a trained model based on one or more updates to the electronic model.

13. The system of claim 1,
wherein the electronic model is a transformer model comprising a plurality of encoders and a plurality of decoders,
wherein the synthetic gradient signal is configured to update at least one decoder among the plurality of decoders or at least one encoder among the plurality of encoders, and
wherein the transformer model performs one or more natural language processing (NLP) operations.

14. A training node, comprising:
a first processor coupled to a first memory;
a second processor coupled to a second memory; and
a synthetic gradient processing unit (SGPU) coupled to a third memory, the first processor and the second processor,
wherein at least a portion of an electronic model is disposed in the first memory, the second memory, and the third memory,
wherein the SGPU generates a synthetic gradient signal based on an error data signal from the first processor and the at least a portion of the electronic model, and
wherein the synthetic gradient signal is configured to update the electronic model during a training operation for the electronic model.

15. The training node of claim 14, wherein the SGPU comprises:
an optical circuit comprising:
an adjustable spatial light modulator coupled to an optical source,
a medium coupled to the adjustable spatial light modulator, and
an optical detector coupled to the medium,
wherein the optical detector is configured to obtain a combined optical signal comprising a resulting optical signal that is produced by transmitting a first optical signal through the medium at a predetermined spatial light modulation using the adjustable spatial light modulator, and
wherein the combined optical signal further comprises a second optical signal from the optical source.

16. The training node of claim 14,
wherein the electronic model comprises a plurality of activation functions, a plurality of hidden layers, and a plurality of weights,
wherein the electronic model generates predicted data based on input data from a training dataset, and
wherein the first processor generates an error data signal based on the difference between the predicted data and output data from the training dataset.

17. The training node of claim 16, further comprising:
a node agent coupled to the SGPU, the first processor, and the second processor,
wherein the node agent obtains, from a distributed training controller, the electronic model, the input data from the training dataset, and the output data from the training dataset, and
wherein the node agent transmits the at least a portion of the electronic model to the SGPU, the first processor, and the second processor.

18. A method, comprising:
obtaining, by a distributed training controller, training data and an electronic model;
determining, by the distributed training controller and based on a distribution algorithm, a resource distribution for updating the electronic model using a plurality of training nodes,
wherein at least one training node among the plurality of training nodes comprises a synthetic gradient processing unit (SGPU), and
wherein the electronic model is updated based on a synthetic gradient signal that is generated by the SGPU in response to an error data signal;
generating, using the plurality of training nodes, the training data, and the resource distribution, a trained model based on the electronic model.

19. The method of claim 18, further comprising:
providing the trained model to an inference server, wherein the trained model performs one or more inference operations at the inference server.

20. The method of claim 18, further comprising:
obtaining, by a training manager coupled to the distributed training controller, a request to train the electronic model; and
obtaining, by the training manager and using a user interface in a user device, a distribution algorithm selection, an electronic model selection, and the training data,
wherein the distribution algorithm corresponds to the distribution algorithm selection, and
wherein a plurality of model parameters of the electronic model correspond to the electronic model selection.
